(19) United States
(12) Patent Application Publication
(10) Pub. No.: US 2022/0227016 A1
(43) Pub. Date: Jul. 21, 2022

(54) RAZOR HANDLE WITH RECYCLED CONTENT

(71) Applicant: Bic Violex S.A., Anoixi (GR)

(72) Inventor: Nikolaos CHATZIGRIGORIOU, Anoixi (GR)

(73) Assignee: Bic Violex S.A., Anoixi (GR)

(21) Appl. No.: 17/596,308

(22) PCT Filed: Jun. 24, 2020
(86) PCT No.: PCT/EP2020/067740

§ 371 Date: Dec. 7, 2021

(30) Foreign Application Priority Data
Jun. 26, 2019 (EP) 19182527.2

(51) Int. Cl. B26B 21/52; B29C 45/14; B29C 45/00

(52) U.S. Cl. CPC B26B 21/528; B26B 21/522; B29L 2031/7186; B29C 45/0001; B29C 45/14819

(57) ABSTRACT

A handle (14) for a skincare device including a core portion (20) made of recycled polymer material and an outer skin portion (22) made of virgin polymer material. A method of manufacturing such a handle (14). A handheld skincare device including such a handle (14) and a skincare kit including such a handle (14) and at least one razor cartridge.

This application is a National Stage application of International Application No. PCT/EP2020/067740, filed on 24 Jun. 2020, now published as WO2020260411 and which claims benefit from European patent application EP19182527.2 filed on 26 Jun. 2019 the entire content being incorporated herein by reference. The present disclosure relates to the field of skincare, and in particular to shaving. More specifically, the present disclosure relates to a handheld skincare device, a handle therefor, and a skincare kit including such a handle.

### TECHNICAL FIELD

### Background

Disposable skincare devices, such as razors, include generally a handle which represents a major part of the disposable device.

Disposable razor handle represents a major part of a disposable razor and is generally bulky and long enough so as to allow a good handle grip during shaving.

Handles are currently produced by fossil based thermoplastic materials, due to the fact that the materials that belong to this group generally reassure that the final handle will have good mechanical properties, decent surface finish and aesthetics, while in the meantime may be produced economically and in high volumes.

However, in parallel, such products have a limited lifetime and are fully discarded after their use. As a result, there is a growing concern that disposable razor products might not be sustainable as they are produced using fossil based plastics and have a limited lifetime usage.

A solution might be to reduce the amount of plastic material that is used to produce a razor and more precisely, the handle that is the largest razor component. The material reduction will lead to a lower plastic consumption, thus providing a more sustainable solution.

In addition, it would be beneficial to use recycled plastic raw material instead of virgin raw material, thus eliminating the need of consuming fossil based raw materials.

However, these approaches may result in a disposable razor handle with poor ergonomics due to the reduced handle weight and also that has unpleasing visual aesthetics and tactile characteristics as well (i.e. surface roughness or glossiness) due to the use of recycled materials and due to not being bulky and with a solid form.

### SUMMARY

The present disclosure provides a handle for a skincare device. The handle may be for a razor. The handle may include a core portion made of recycled polymer material and an outer skin portion made of virgin polymer material, wherein the virgin polymer material is substantially compatible with the recycled polymer material. The core portion may be in contact with the outer skin portion, more specifically the outer skin portion may be overmolded onto the core portion.

The recycled material may be of the same type with the virgin polymer material. According to the present disclosure, materials of “same type” means materials of same chemical nature. For example, in case of polymer materials, polymers or copolymers of the same type means polymers or copolymers being made of the same monomer(s). Polymers having different degrees of polymerization and therefore different molecular weights should be considered as of the same type.

The recycled material may be a mixed recycled material comprising at least one material of the same type with the virgin polymer material and at least one material of a different type. According to the present disclosure, materials of “different type” means materials of different chemical nature.

The material of a different type may comprise a thermoplastic elastomer (TPE) material.

The handle may be a handle for a disposable skincare device.

The handle may comprise a grip made of an elastomeric material.

The grip may cover at least 5-75% of the outer surface of the handle.

The grip may cover at least 16-65% of the outer surface of the handle.

The grip may cover at least 20-55% of the outer surface the handle.

The core portion volume content may be equal to or greater than 40 vol % of the handle.

The core portion volume content may be equal to or greater than 50 vol % of the handle and equal to or smaller than 90 vol %.

The core portion volume content may be equal to or greater than 60 vol % of the handle and equal to or smaller than 85 vol %.

The outer skin portion may cover at least 50% of the external surface of the core portion.

The outer skin portion may cover at least 70% of the external surface of the core portion.

The outer skin portion may cover at least 90% of the external surface of the core portion.

The core portion and the outer skin portion may comprise the same polymer material type. In particular, the recycled material of the core portion may be of the same type with the virgin polymer material of the outer skin portion.

The core portion may be made of/may comprise recycled polypropylene (PP) and the outer skin portion may be made of virgin polypropylene.

The core portion may be made of/may comprise recycled high impact polystyrene and the outer skin portion may be made of virgin high impact polystyrene.

The core portion may be made of/may comprise recycled acrylonitrile butadiene styrene (ABS) and the outer skin portion may be made of virgin acrylonitrile butadiene styrene.

The recycled polymer material may be a pre-consumer recycled polymer material.

The recycled polymer material may be a post-consumer recycled polymer material.

The ISO standard definition of post- and pre-consumer materials are (ISO 14021:2016):
Pre-consumer material—Material diverted from the waste stream during a manufacturing process. Excluded is reutilization of materials such as rework, regrind or scrap generated in a process and capable of being reclaimed within the same process that generated it;
Post-consumer material—Material generated by households or by commercial, industrial and institutional facilities in their roles as end-users of the product which can no longer be used for its intended purpose. This includes returns of material from the distribution chain.

The present disclosure also provides a method of manufacturing an above-defined handle. The method may include the following steps, of producing the core portion (20) of recycled polymer in a dedicated mold and machine transferring and inserting the core portion (20) into a second mold/machine, and injecting the outer skin portion (22) made of virgin polymer material.

The present disclosure also provides a method of manufacturing an above-defined handle. The method may include co-injecting the recycled polymer and the virgin polymer material in a manner that the recycled material flows towards the core portion of the plastic handle and the virgin material flows towards the outer surfaces thereby forming the outer skin portion encapsulating the core portion.

The present disclosure also provides a handheld skincare device including an above-defined handle.

The present disclosure also provides a skincare kit including an above-defined handle and at least one razor cartridge.

Thanks to the core portion made of recycled polymer material, the consumption of fossil based raw materials is reduced.

Thanks to the outer skin portion made of virgin polymer material, the mechanical and visual properties of the recycled polymer material are compensate by the use of virgin polymer material and the handle has good mechanical properties, might be colored and present a pleasing surface, i.e., good surface finish.

Moreover, the recycled polymer material may be a product of secondary recycled plastic (pre or post consumer) process. For example, the recycled plastic may be partially or fully collected by the ocean plastic waste or municipal waste and it may then be sorted based on plastic type (for example recycled polypropylene or recycled High Impact polystyrene or recycled ABS).

The outer skin material is a virgin plastic, that may be fully compatible (meaning that has similar composition that provide a good adhesion) with the inner core made of recycled plastic. The outer skin material has good mechanical properties and is applied to all parts of the handle where there is a need of good mechanical properties so as to reassure the proper handle function (head connection area, pivoting tongue). The virgin plastic material also has the ability to be colored easily and provides good surface aesthetics compared to the recycled plastic material used for the core.

Furthermore, the two materials (recycled core and virgin skin) may belong to the same plastic type so as to facilitate their common recycling, thus eliminating the possibility of contaminating the recycling stream.

Recycling process takes place either by using raw materials of same type or raw materials of different type. In the case of raw materials of the same type, the recycled material created has similar properties with the raw material. In the case of raw materials from different types (e.g. plastics and rubbers, or ABS and PP, etc), a mixed recycled material is created with substantially different properties.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

### BRIEF DESCRIPTION OF THE DRAWINGS

The disclosure may be more completely understood in consideration of the following detailed description of aspects of the disclosure in connection with the accompanying drawings, in which:

FIG. 1 shows a representation of an exemplary handle according to embodiments of the present disclosure;

FIG. 2 shows a representation of another exemplary handle according to embodiments of the present disclosure;

FIG. 3 shows a representation of another exemplary handle according to embodiments of the present disclosure;

FIG. 4 shows a representation of another exemplary handle according to embodiments of the present disclosure;

FIG. 5 shows a representation of an exemplary handheld skincare device including an exemplary handle;

FIG. 6 shows a representation of an exemplary skincare kit comprising an exemplary handle; and

FIG. 7 shows a flow chart of a method for producing an exemplary handle.

While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

### DETAILED DESCRIPTION

Reference will now be made in detail to exemplary embodiments of the disclosure, examples of which are illustrated in the accompanying drawings. Wherever possible, the same reference numbers will be used throughout the drawings to refer to the same or like parts.

As used in this disclosure and the appended claims, the singular forms “a”, “an”, and “the” include plural referents unless the content clearly dictates otherwise. As used in this disclosure and the appended claims, the term “or” is generally employed in its sense including “and/or” unless the content clearly dictates otherwise.

The following detailed description should be read with reference to the drawings. The detailed description and the drawings, which are not necessarily to scale, depict illustrative aspects and are not intended to limit the scope of the disclosure. The illustrative aspects depicted are intended only as exemplary.

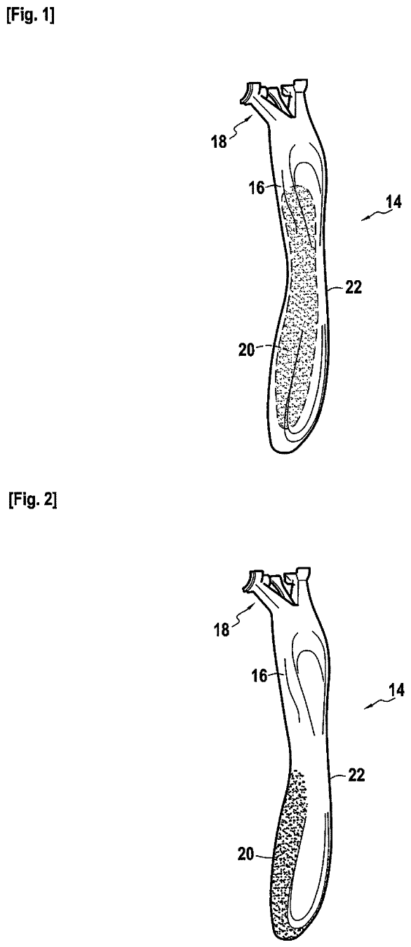

FIG. 1 shows a representation of an exemplary handle 14 for a skincare device 10, for example for a disposable handle for a razor.

The handle 14 may include a body 16 and a connector portion 18. The body 16 may include a core portion 20 made of recycled polymer material and an outer skin portion 22 made of virgin polymer material. For understanding purpose, the core portion 20 is seen through the outer skin portion 22. However, in the handle 14, the outer skin portion 22 may not be made transparent and/or translucent so that, the core portion 20 is not seen through the outer skin portion 22. The connector portion 18 is made of virgin polymer material.

In the exemplary handle 14 of FIG. 1, the core portion 20 is completely covered by the outer skin portion 22. The core portion volume content may be equal to or greater than 40 vol %, specifically equal to or greater than 50 vol % and equal to or smaller than 90 vol %, more specifically equal to or greater than 60 vol % and equal to or smaller than 85 vol %, of the handle. The outer skin portion may cover 100% of the external surface of the core portion.

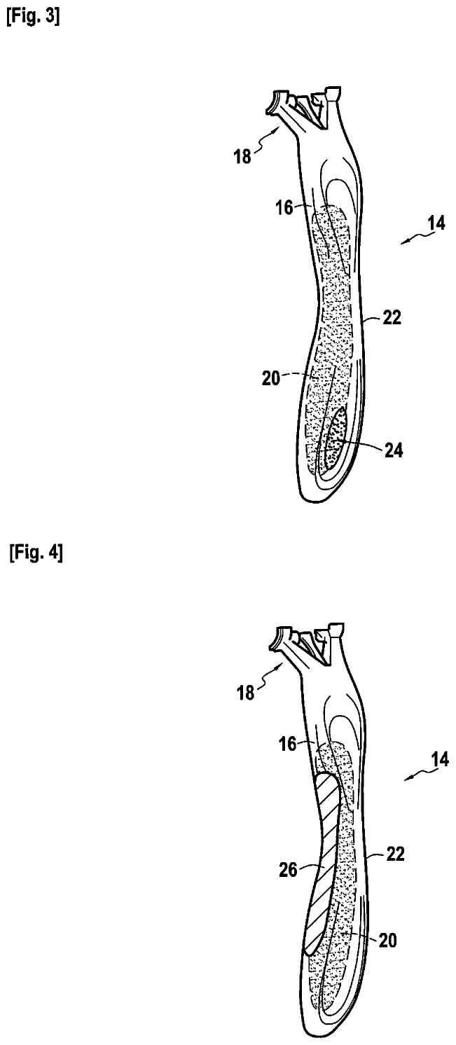

In the exemplary handle 14 of FIG. 2, the core portion 20 is not completely covered by the outer skin portion 22. The core portion volume content may be equal to or greater than 40 vol %, specifically equal to or greater than 50 vol % and equal to or smaller than 90 vol %, more specifically equal to or greater than 60 vol % and equal to or smaller than 85 vol %, of the handle. The outer skin portion may cover 100% of the external surface of the core portion.

In the exemplary handle 14 of FIG. 3, the outer skin portion 22 presents a window 24 through which the core portion 20 may be seen. The core portion volume content may be equal to or greater than 40 vol %, specifically equal to or greater than 50 vol % and equal to or smaller than 90 vol %, more specifically equal to or greater than 60 vol % and equal to or smaller than 85 vol %, of the handle. The outer skin portion may cover at most 90% of the external surface of the core portion.

The exemplary handle 14 of FIG. 4 is similar to the one of FIG. 1. The exemplary handle of FIG. 4 may include a grip 26 made of elastomer, for example a thermoplastic elastomer. The exemplary handle 14 may include two grips 26 made of thermoplastic elastomer, one on each side of the handle. The grip 26 made of thermoplastic elastomer may be continuous from one side to the other side of the handle 14. It is to be understood that the number and the location of grip(s) made of thermoplastic material on FIG. 4 are a non-limiting example. The core portion volume content may be equal to or greater than 40 vol %, specifically equal to or greater than 50 vol % and equal to or smaller than 90 vol %, more specifically equal to or greater than 60 vol % and equal to or smaller than 85 vol %, of the handle. The outer skin portion may cover 100% of the external surface of the core portion. The grip 26 covers at least 5% of an outer surface of the handle.

As non-limiting example, the handle 14 may include a core portion 20 made of recycled ABS and an outer skin portion 22 made of virgin ABS. Virgin ABS may have flexural modulus of elasticity (ISO 178) of 2300 MPa. Recycled ABS may have flexural modulus of elasticity 2200-2600 MPa. Virgin ABS may have an impact strength resistance (24 kJ/m²), measured by Izod-Notched method (ISO 180), which may be at least twice the impact strength resistance of the recycled ABS (11-12 kJ/m²).

As non-limiting example, the handle 14 may include a core portion 20 made of recycled PP and an outer skin portion 22 made of virgin PP. Virgin PP (1700 MPa) may have tensile modulus of elasticity (ISO 527-1) which is higher than the module of elasticity of a recycled PP (750-1300 MPa) and an impact strength resistance (6.5 kJ/m²), measured by Charpy method (ISO 179), which may be similar to the impact strength resistance of the recycled PP (6-7 kJ/m²).

The values given for the virgin ABS, recycled ABS, virgin PP and recycled PP are given as non-limiting examples. It is understood that the measurements are given as comparative measurements. Thus, as long as the measuring methods used are used for both virgin and recycled material, the measured obtained may be compared between the virgin material and the recycled material.

In general, the recycling of multi-plastic articles is challenging, especially in the case when the different plastic type components of the article are chemically bonded together. In this case, it is not possible or viable to separate and sort the individual materials, thus a possible scenario is to either dispose the mixed plastic as waste for landfill or incineration or to blend it into a multiphase material with inferior properties due to the variable and non-homogeneous feedstock. This problem is especially frequent for multi-material plastic articles that are produced via overmoulding a TPE material on a hard plastic substrate. Such articles are very difficult (if not impossible) to recycle them in a closed loop approach, as the final blended material does not have the adequate and constant properties to be used in the same application. As a result, in this case the material is deemed to be downcycled into less demanding applications. For example, a company selling shavers could collect back and recycle old shaver handles in order to make new ones and so on. By applying this mixed plastic insert molding technique, the recycling process of the multi-material article becomes viable and the final material can be effectively reused into the same application (closed loop recycling). An example of a closed loop recycling may be the recycling of an old handle made of a hard plastic substrate of PP 80% by weight and Calcium Carbonate filler 20% by weight and an elastomeric grip portion made of TPE compound. All materials are recycled together since it is hard to be separated and a mixed recycled material is created including all the above-mentioned materials. This mixed recycled material shall be used for the core portion of a new handle whereas a virgin PP material and a calcium carbonate filler will be used for the outer skin portion. All these materials will be substantially compatible, thus providing a robust structure. According to the present disclosure, “substantially compatible materials” or “compatible materials” should be understood as materials (or mixtures of materials) that can be mixed together and thereby forming a homogeneous mixture. Compatibility can be defined as a measure of how stable is one first material (e.g. material of one type) or a first mixture of materials (e.g. a mixed material) when mixed together or is in contact with (e.g. being overmolded on) a second material or a second mixture of materials. In particular, each material (or mixture of materials) retains its properties, while the mixed materials or the materials in contact (e.g. overmolded) form a chemical bond and/or chemical interaction with each other. The compatibility of the materials ensure the robustness of the structure, in particular the compatibility of the materials of the outer skin portion and of the core portion leads to enhanced adhesion between the latter two portions, more specifically when the outer skin portion is overmolded onto the core portion, for example in an overmolding step of the outer skin portion or in a co-injection process of the outer skin portion and of the core portion. In examples, some materials such as TPE may be used to compatibilize a mixture of different materials, e.g. a mixture comprising a plastic material such as ABS and the TPE and/or a filler. Additionally, the core portion and the outer skin portion may be mechanically bonded together through a mechanical interlock applied to enhance the robustness of the structure, whereby anchoring the outer skin portion on the core portion. For example, the mechanical interlock can be set in function through apertures that allow the anchoring, e.g. apertures in T-shape form. In examples, the grip and the outer skin portion may also be mechanically bonded together through a mechanical interlock.

Therefore, a mixed material may be a blend of a more than one material of the same and/or different types (e.g. plastics and/or thermoplastic elastomers). A mixed recycled material may be a blend of a more than one material of the same and/or different types (e.g. plastics and/or thermoplastic elastomers) having undergone recycling process. As a non-limiting example, the mixed recycled material may include recycled ABS and recycled TPE. As a non-limiting example, the mixed recycled material my include both recycled and virgin materials. The addition of virgin material may further improve the properties of the mixed recycled material. Furthermore, the mixed recycled material that also includes a soft plastic or rubber (e.g. thermoplastic elastomer) may also serve for a grip feature without having to add virgin rubber portions on the handle. This may be achieved by having some portions of the core not covered by the outer skin portion 22. Thus, less virgin rubber material is used.

As non-limiting example, the handle 14 may include a core portion 20 made of a recycled mixed material and an outer skin portion 22 made of virgin material. The core and the outer skin portion may be substantially compatible and possible to be chemically bonded to each other. This way the amount of the new virgin material that will be needed is limited and the connection between the two materials will be acceptable. In the case that the core portion 20 and the outer skin portion 22 are made of materials of totally different type, they are not being bonded together efficiently and may be separated or generally fail to provide a common structure. This may further deteriorate when the core portion 20 is partially covered by the outer skin portion 22. By using a recycled mixed material for the core portion 20 which contains at least one compatible material with the material of the outer skin portion 22, this problem could be overcome.

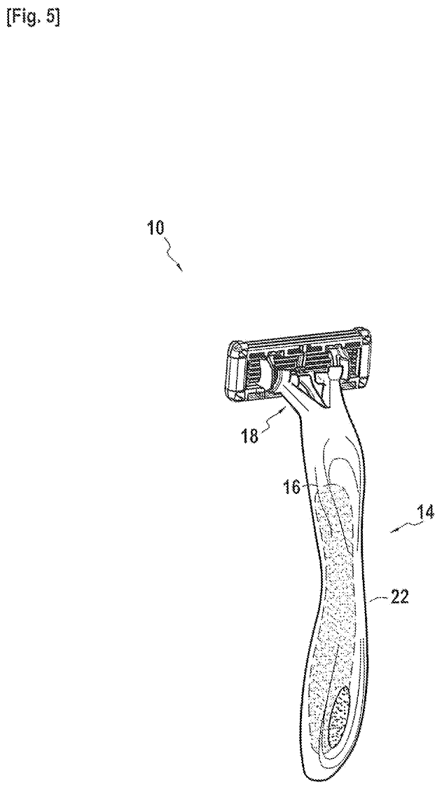

FIG. 5 shows a handheld skincare device 10. The handheld skincare device 10 may be a disposable razor and may include an exemplary handle 14 and a shaving head 12.

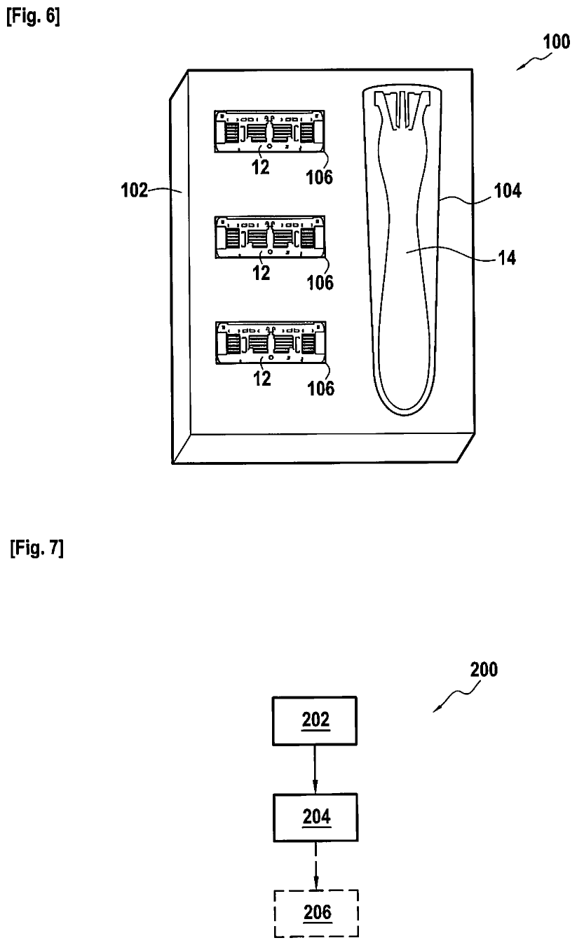

FIG. 6 shows a skincare kit 100. The skincare kit 100 may be housed within a packaging including a support 102 with a base 104 for supporting a handle 14 substantially as described herein and a plurality of cavities 106 for receiving shaving heads 12. In alternatives, the kit may include other type of heads such as exfoliation head, massage head, cooling head and/or any other known skin treatment head configured to be attached with a handle as disclosed herein. In alternatives, different shaving cartridges may be provided in the kit, e.g., a three-blade shaving cartridge, a two-blade shaving cartridge and a four-blade shaving cartridge. Other combinations may also be foreseen as well as other number of cartridges. As represented at FIG. 6, the skincare kit 100 may include three cavities 106 and three shaving heads 12. It is to be understood that the number of cavities 106 and shaving heads is a non-limiting example.

The handle 14 may be produced by insert injection molding process 200, as represented at the flowchart of FIG. 7. In a first step 202 of the process, the core portion 20 made of recycled polymer material is produced in a dedicated mold and machine. In a second step 204, the core portion 20 is then transferred and inserted in a second mold/machine, where the outer skin portion 22 made of virgin polymer material is injected, thus forming the solid handle 14. Particularly, the handle 14 may be produced by an overmolding process.

Alternatively and following this second step 202, in a third step 206, a third material, for example a portion made of virgin thermoplastic elastomer (TPE), for example the grip 26, may be also injected on top of the outer skin portion 22 so as to provide a soft gripping feature or color differentiation. This third injection step 206 may take place in the same mold that the outer skin portion 22 plastic injection took place (over molding).

Alternatively, the same concept may be followed by a double or triple injection concept where the core portion 20 made of recycled polymer material is injected in the first step 202, then the outer skin portion 22 made of virgin polymer material is injected in the second step 204 and in the case of triple injection, the third material, for example TPE, is injected in the third step 206. All three steps may be carried out in the same mold/machine.

Alternatively, the same concept may be followed by a sandwich co-injection concept, where the recycled material and the virgin material are injected from a sandwich/multi-material injection gate in a manner that the recycled material flows towards the core of the plastic handle and the virgin plastic flows towards the outer surfaces thus encapsulating the recycled core. Alternatively, the co-injection may use more than one injection gate located in different locations. Particularly, the co-injection concept leads to an overmolded outer skin portion onto the core portion.

Alternatively and following this step, a further material, for example TPE, may be also injected on top of the outer skin portion 22 so as to provide a soft gripping feature. This injection step may take place in the same mold that the sandwich injection of the recycled and the virgin plastic took place (over-molding).

Alternatively, the same may be realized by assembling a core portion 20 made of recycled polymer material into a pre-molded outer skin portion 22 made of virgin polymer material.

Where any standards of national, international, or other standards body are referenced (e.g., ISO, etc.), such references are intended to refer to the standard as defined by the national or international standards body as of the priority date of the present specification. Any subsequent substantive changes to such standards are not intended to modify the scope and/or definitions of the present disclosure and/or claims.

Although the described embodiments were provided as different exemplary embodiments, it is envisioned that these embodiments are combinable or, when not conflicting, the features recited in the described embodiments may be interchangeable. Moreover, the features recited in the described embodiments are not inextricably linked to one another, unless such a linkage is clearly indicated between two given features.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A handle for a skincare device, the handle comprising a core portion made of recycled polymer material and an outer skin portion made of virgin polymer material, wherein the virgin polymer material is substantially compatible with the recycled polymer material.

2. The handle according to claim 1, wherein the core portion is in contact with the outer skin portion.

3. The handle according to claim 1, wherein the outer skin portion is overmolded onto the core portion.

4. The handle according to claim 1, wherein the handle comprises a grip made of an elastomeric material.

5. The handle according to claim 1, wherein the core portion volume content is equal to or greater than 40 vol % of the handle, specifically equal to or greater than 50 vol % and equal to or smaller than 90 vol %, more specifically equal to or greater than 60 vol % and equal to or smaller than 85 vol %.

6. The handle according to claim 1, wherein the outer skin portion covers at least 50% of the external surface of the core portion, specifically at least 70%, more specifically at least 90%.

7. The handle according to claim 1, wherein the grip covers at least 5-75% of the outer surface of the handle, specifically at least 15-65%, more specifically at least 20-55%.

8. The handle according to claim 1, wherein the core portion and the outer skin portion comprise the same polymer material type.

9. The handle according to claim 1, wherein the core portion is made of recycled polypropylene and the outer skin portion is made of virgin polypropylene.

10. The handle according to claim 1, wherein the core portion is made of recycled high impact polystyrene and the outer skin portion is made of virgin high impact polystyrene.

11. The handle according to claim 1, wherein the core portion is made of recycled acrylonitrile butadiene styrene and the outer skin portion is made of virgin acrylonitrile butadiene styrene.

12. The handle according to claim 1, wherein the recycled material of the core portion is a mixed recycled material comprising at least one material of the same type with the virgin polymer material of the outer skin portion and at least one material of a different type.

13. The handle according to claim 12, wherein the material of a different type comprises a thermoplastic elastomer material.

14. The handle according to claim 1, wherein the recycled polymer material is a pre-consumer recycled polymer material.

15. The handle according to claim 1, wherein the recycled polymer material is a post-consumer recycled polymer material.

16. A method of manufacturing a handle according to claim 1, wherein the method comprises the following steps, of producing the core portion of recycled polymer in a dedicated mold and machine transferring and inserting the core portion into a second mold/machine, and injecting the outer skin portion made of virgin polymer material.

17. A method of manufacturing a handle according to, claim 1, wherein the method comprises co-injecting the recycled polymer and the virgin polymer material in a manner that the recycled material flows towards the core portion of the plastic handle and the virgin material flows towards the outer surfaces thereby forming the outer skin portion encapsulating the core portion.

18. A handheld skincare device comprising a handle according to claim 1.

19. A skincare kit comprising a handle according to claim 1 and at least one razor cartridge.

20. A razor comprising a handle, the handle comprising a core portion made of recycled polymer material and an outer skin portion made of virgin polymer material, wherein the virgin polymer material is substantially compatible with the recycled polymer material.
